(19) United States
(12) Patent Application Publication
(10) Pub. No.: US 2010/0267426 A1
(43) Pub. Date: Oct. 21, 2010

(54) MOBILE COMMUNICATION TERMINAL

(75) Inventors: Sang-Kyun Kang, Seongnam-si (KR); Duck-Hyun Kim, Seoul (KR); Kun Joo Yang, Seoul (KR); Gil Young Lim, Seoul (KR); Sang Hyun Han, Incheon (KR)

Correspondence Address: H.C. PARK & ASSOCIATES, PLC, 8500 LEESBURG PIKE, SUITE 7500, VIENNA, VA, 22182, US

(73) Assignee: PANTECH & CURITEL COMMUNICATIONS, INC., Seoul (KR)

(21) Appl. No.: 12/635,376

(22) Filed: Dec. 10, 2009

(30) Foreign Application Priority Data
Apr. 21, 2009 (KR) 10-2009-0034554

(51) Int. Cl. H04W 88/02; H04M 1/00

(52) U.S. Cl. 455/575.1

(57) ABSTRACT

A mobile communication terminal includes an upper body, a lower body and a swivel hinge unit connecting the upper body and the lower body such that the lower body swivels about the upper body. Before the swiveling movement, the upper and lower bodies form a horizontal axis, and the swivel hinge unit has a central axis arranged with an inclined angle with respect to the horizontal axis. After the swiveling movement, the upper and lower bodies are arranged relative to each other to form an obtuse tilting angle. The inclined angle of the swivel hinge unit is ½ of the tilting angle, and the tilting angle can be 5° to 30°. The upper body includes a display, and the lower body includes a key input unit.

### CROSS-REFERENCE TO RELATED APPLICATION

This application claims priority from and the benefit of Korean Patent Application No.10-2009-0034554, filed on Apr. 21, 2009, which is hereby incorporated by reference for all purposes as if fully set forth herein.

### BACKGROUND OF THE INVENTION

1. Field of the Invention

This disclosure relates to a mobile communication terminal, and more particularly to a mobile communication terminal having an upper body and a lower body connected together by a swivel hinge unit that changes the relative angles formed by the upper body and the lower body according to a swiveling movement.

2. Discussion of the Background

Currently, a mobile communication terminal may include not only a basic telephone call function but also functions for listening to music, playing games, receiving and displaying photos and video images, capturing and storing photos and videos, and so on, and the design and structure of the mobile communication terminal should adapt according to those functions.

For example, a swivel-type mobile communication terminal may have an upper body and a lower body that may be rotated with respect to each other.

However, as shown in FIG. 1A, FIG. 1B, and FIG. 1C, in the general swivel-type mobile communication terminal 10, an upper body 12 and a lower body 14 maintain a constant angle before and after the swiveling movement.

Thus, as shown in FIG. 2A, in order to watch an image displayed on display 18, a user may raise the mobile communication terminal 10 substantially vertically such that the user's gaze X faces the display 18. In this case, the wrist of the user gripping the lower body 12 including the speaker 20 and the key input unit 16 is also folded toward the user's body, and the user's thumb Y is raised upward, so the user's thumb Y may get stiff. Further, it may be difficult to manipulate the key input unit 16 while watching the display 18.

The user may stretch out the wrist as shown in FIG. 2B to relax the user's hand. However, this position of the mobile communication terminal 10 may reduce the visibility of the display 18.

### SUMMARY OF THE INVENTION

Exemplary embodiments of the present invention provide a mobile communication terminal having an upper body and a lower body, which form different angles is relative to each other before and after the swiveling movement such that the upper body and lower body may be tilted relative to each other.

Additional features of the invention will be set forth in the description which follows, and in part will be apparent from the description, or may be learned by practice of the invention.

An exemplary embodiment of the present invention discloses a mobile communication terminal, including an upper body, a lower body and a swivel hinge unit connecting the upper body to the lower body. The swivel hinge unit is to perform a swiveling movement of the lower body relative to the upper body from a first position to a second position. Further, the swivel hinge unit rotates about a central axis arranged with an inclined angle with respect to a first axis formed by the upper body and the lower body in the first position. Also, the upper body and the lower body in the second position are bent relative to each other at a tilting angle.

An exemplary embodiment of the present invention discloses a mobile communication terminal, including an upper body, a lower body and a swivel hinge unit connecting the upper body to the lower body, the swivel hinge unit to swivel the lower body from a first position to a second position relative to the upper body. Further, the upper body and the lower body in the first position form a first angle, and the upper body and the lower body in the second position form a second angle, and the first angle and the second angle are different.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A, FIG. 1B, and FIG. 1C are perspective views showing a general swivel-type mobile communication terminal, in which a swiveling movement is sequentially depicted.

FIG. 2A and FIG. 2B are schematic perspective views showing the general swivel-type mobile communication terminal being gripped and used.

FIG. 3A, FIG. 3B, and FIG. 3C are perspective views showing a swivel-tilting-type mobile communication terminal according to an exemplary embodiment of the present invention, in which a swiveling movement of a lower body is sequentially depicted.

FIG. 4A and FIG. 4B are schematic side sectional views showing the swivel-tilting-type mobile communication terminal according to an exemplary embodiment of the present invention, which figures respectively correspond to FIG. 3A and FIG. 3C.

FIG. 5 is a schematic view showing the swivel-tilting-type mobile communication terminal according to an exemplary embodiment of the present invention being used.

FIG. 6 is a schematic view showing the mobile communication terminal according to an exemplary embodiment of the present invention, which is swivel-tilted and used for a telephone call.

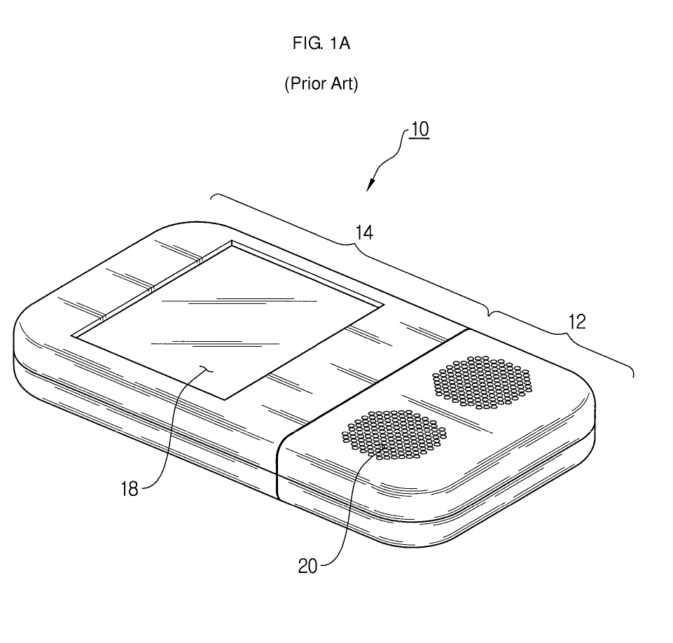

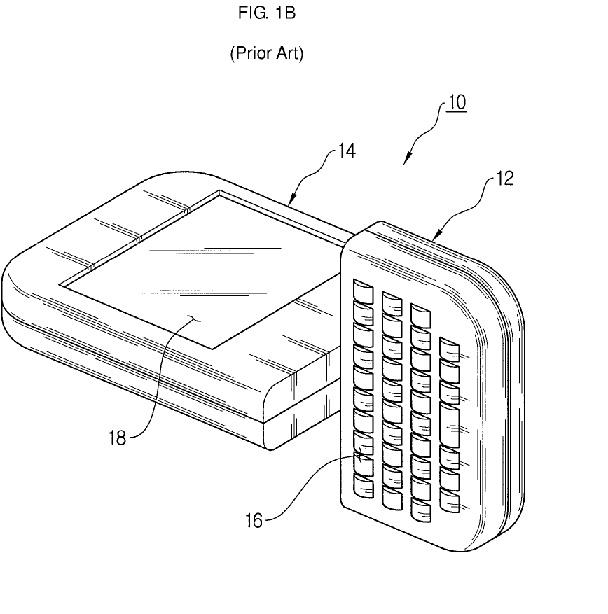

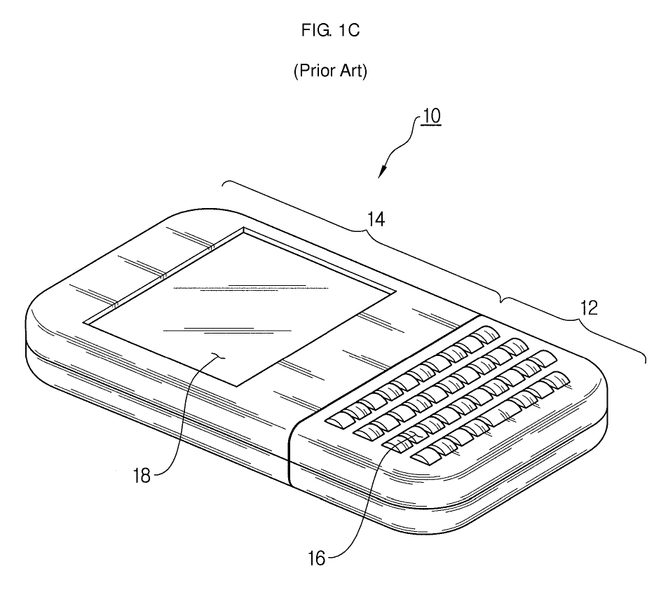

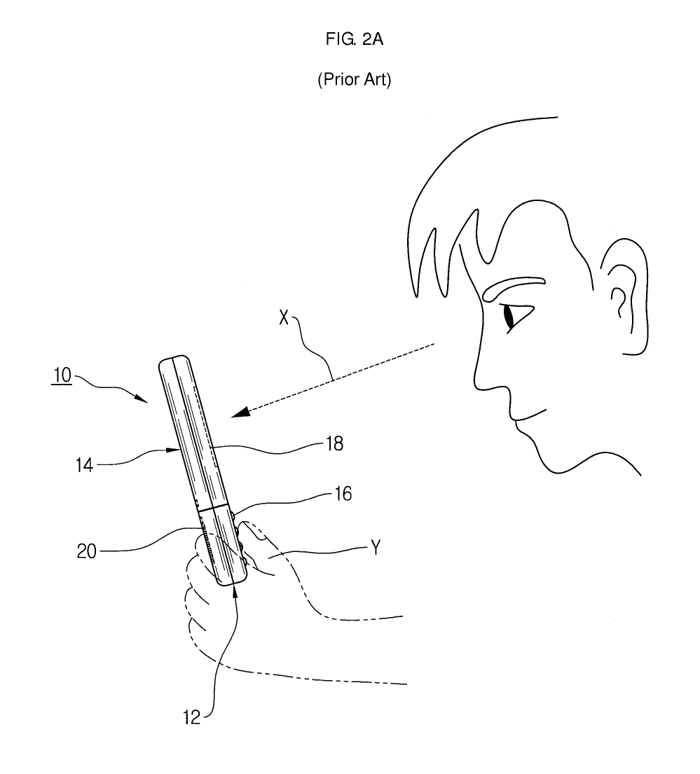

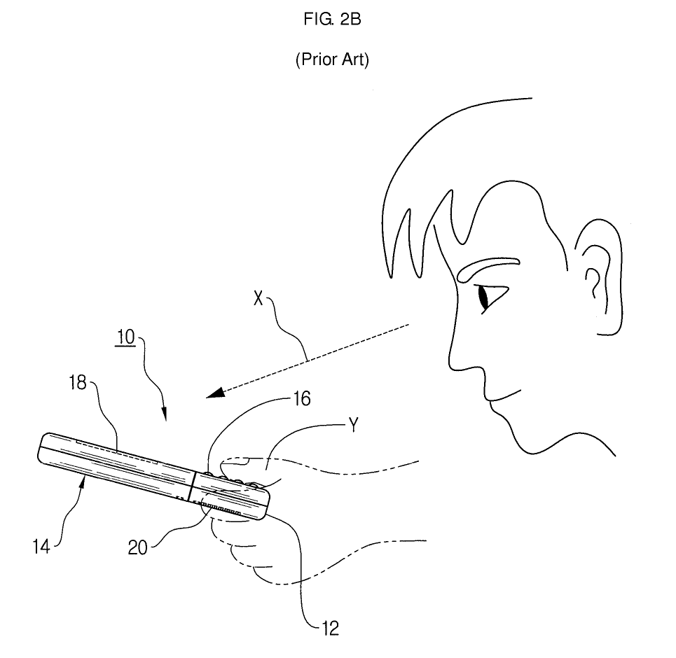

### DETAILED DESCRIPTION OF THE ILLUSTRATED EMBODIMENTS

Exemplary embodiments now will be described more fully hereinafter with is reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, is should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

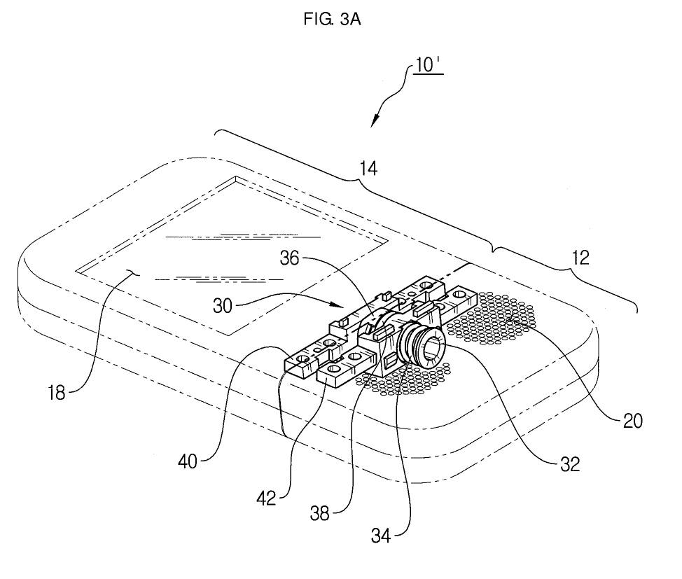

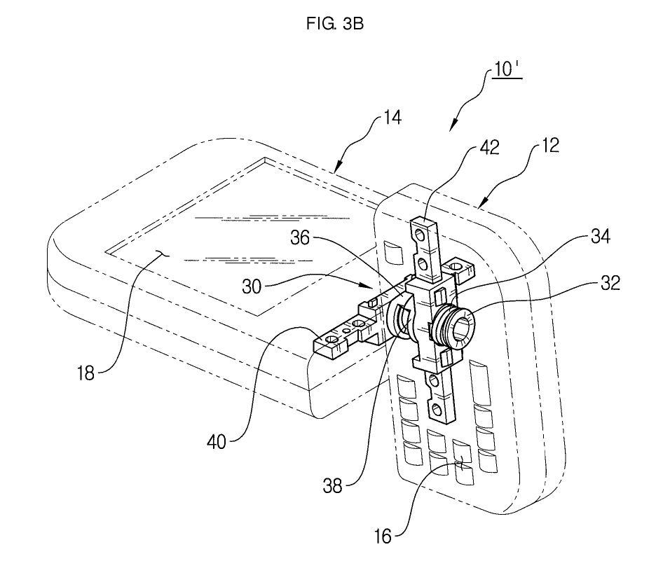

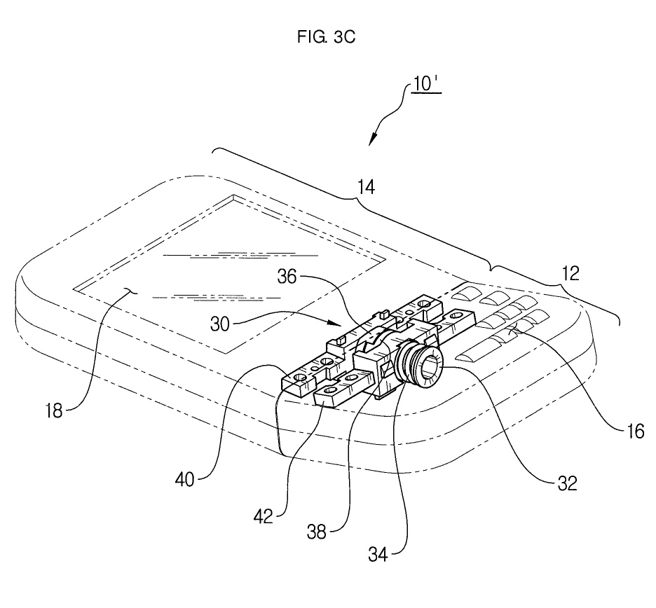

FIG. 3A, FIG. 3B, and FIG. 3C are perspective views showing a swivel-tilting-type mobile communication terminal according to an exemplary embodiment, in which a swiveling movement of a lower body is sequentially depicted. In FIG. 3A, FIG. 3B, and FIG. 3C, upper body 14 and lower body 12 are depicted as a line of alternating long dashes and two short dashes such that the interior may be revealed.

Hereinafter, a swivel-tilting movement of a mobile communication terminal 10′ according to this exemplary embodiment is explained with reference to FIG. 3A, FIG. 3B, and FIG. 3C. As shown in FIG. 3A, a display 18 of an upper body 14 is initially arranged on the same side as a speaker 20 of the lower body 12.

Before a swiveling movement of a lower body 12, the upper body 14 and lower body 12 are in a first position and are arranged along a horizontal angle with each other.

If the lower body 12 makes a swivel-tilting movement as shown in FIG. 3B toward a second position where the display 18 of the upper body 14 is on the same side as a key input unit 16 of the lower body 12 as shown in FIG. 3C, the upper body 14 and lower body 12 form an obtuse angle relative to each other in the second position.

Hereinafter, an arrangement of a swivel-hinge unit 30 arranged at a border between the upper body 14 and lower body 12 to perform the swiveling movement and the tilting movement is explained with reference to the accompanying drawings.

The swivel-hinge unit 30 includes a hinge shaft 32 extending into the upper body 14 and the lower body 12 at a border of the upper body 14 and lower body 12, an elastic spring 34 coupled to the hinge shaft 32 in the lower body 12, an upper cam 36 rotatably coupled to the hinge shaft 32 in the upper body 14, and a lower cam 38 rotatably coupled to the hinge shaft 32 between the elastic spring 34 and the upper cam 36 and engaged with a cam shape of the upper cam 36.

Also, the swivel-hinge unit 30 includes an upper fixed wing 40 attached to the upper cam 36 and pivotally coupled to one end of the hinge shaft 32, and a lower fixed wing 42 attached to the lower cam 38 and pivotally coupled to the hinge shaft 32 between the lower cam 38 and the elastic spring 34.

A coupling member (not shown) such as one or more screws may be coupled through the upper fixed wing 40 and lower fixed wing 42 to the upper body 14 and lower body 12, respectively, or an interior part (not shown) of the upper body 14 and lower body 12, so the swivel-hinge unit 30 is coupled to the upper body 14 and lower body 12 via the upper fixed wing 40 and lower fixed wing 42, respectively.

Such a structure for connecting the swivel-hinge unit 30 to the upper body 14 and lower body 12 may be easily understood by those having ordinary skill in the art, and other various applications would be also available.

If the lower body 12 makes a swiveling movement, the lower cam 38 working together with the lower body 12 makes a swiveling movement along the cam shape of the upper cam 36. During the swiveling movement, the lower cam 38 compresses the elastic spring 34 due to the cam shape of the upper cam 36. Before and after the swiveling movement, the upper cam 36 and lower cam 38 remain engaged with each other. While the upper cam 36 and lower cam 38 are engaged, the elastic force of the elastic spring 34 is applied to the lower cam 38, so the upper cam 36 and lower cam 38 remain engaged throughout the swiveling movement. A contact surface of the upper cam 36 to the lower cam 38 may be arranged at an angle relative to a rotational axis of the swivel-hinge unit 30, and this angle may cause the lower body 12 to tilt relative to the upper body 14 with the swivel movement.

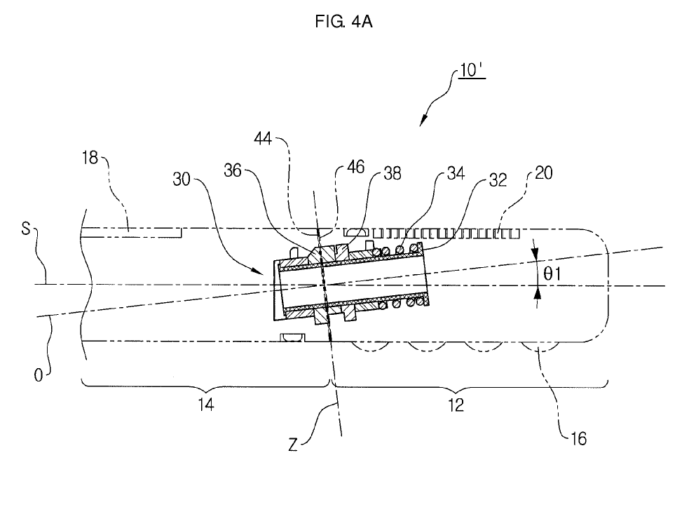

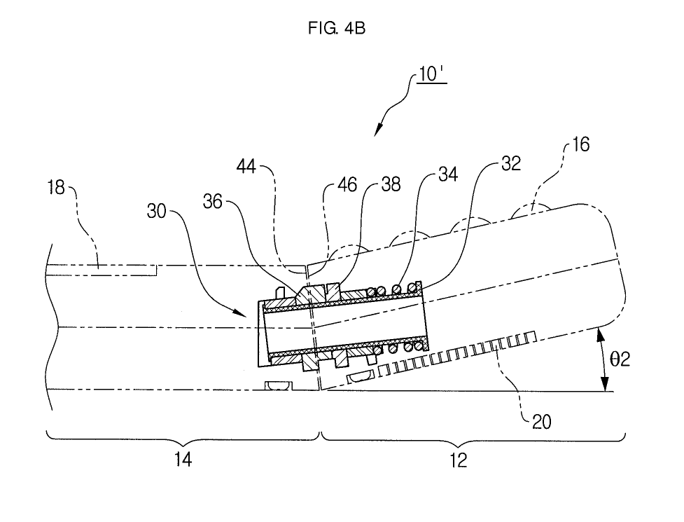

FIG. 4A and FIG. 4B are schematic side sectional views showing the swivel-tilting-type mobile communication terminal according to an exemplary embodiment disclosed herein, which respectively show the states before and after the swivel-tilting movement. These figures respectively correspond to FIG. 3A and FIG. 3C.

As shown in FIG. 4A and FIG. 4B, the swivel hinge unit 30 is disposed at the border between the upper body 14 and the lower body 12. The swivel hinge unit 30 may be arranged with a slant with respect to a horizontal axis S of the mobile communication terminal 10′.

In more detail, as shown in FIG. 4A, before the swiveling movement, based on the horizontal axis S, one end of the swivel hinge unit 30 is adjacent to an upper surface of the lower body 12, and the other end is adjacent to a lower surface of the upper body 14, so a central axis O of the swivel hinge unit 30 has an inclined angle θ1 with respect to the horizontal axis S. Thus, the swivel hinge unit 30 is disposed with a slant relative to the upper body 14 and lower body 12 before the swiveling movement.

In this exemplary embodiment, the inclined angle θ1 of the swivel hinge unit 30 is ½ of a tilting angle θ2 shown in FIG. 4B, and the tilting angle θ2 may be 5° to 30°. Thus, the inclined angle θ1 may be 2.5° to 15°.

If the tilting angel θ2 is less than or greater than the range of 5° to 30°, after the is swivel-tilting movement, the upper body 14 and lower body 12 may be disposed substantially with a straight or similar angle, or the upper body 14 and lower body 12 may be excessively angled relative to each other.

In other words, if the tilting angel θ2 is smaller than 5°, a user may need to raise the upper body 14 in a vertical direction to conform his/her gaze X to face the display 18. Conversely, if the tilting angel θ2 is greater than 30°, a user may need to lower the upper body 14 toward a horizontal direction to conform his/her gaze X to face the display 18. Thus, the manipulation of the key input unit 16 may be less convenient.

Additionally, if the tilting angle θ2 is greater than 30°, the tilting angle θ1 is also increased. Thus, the swivel hinge unit 30 may be disposed substantially closer to a vertical direction according to the relationship between the tilting angle θ2 and the inclined angle θ1, and this may increase the thickness of the mobile communication terminal 10′. Further, a slimmer design may be more desirable for the mobile communication terminal 10′

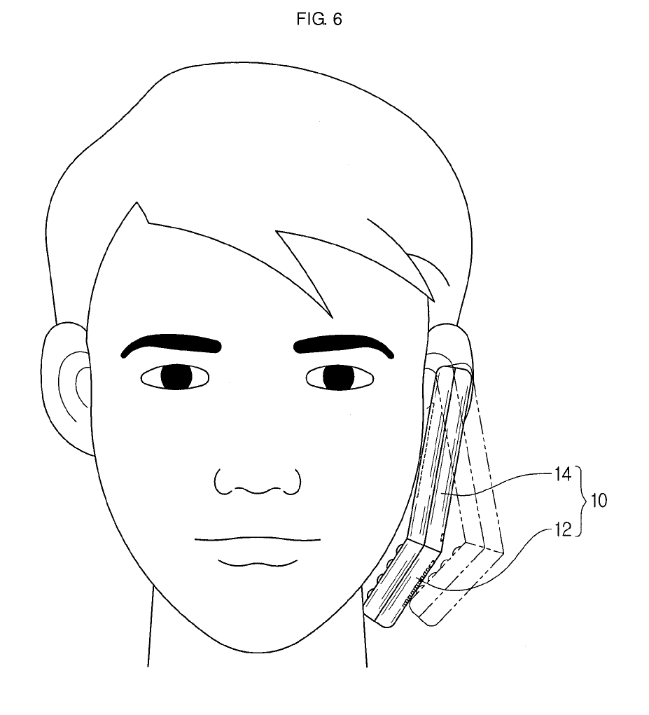

In addition, if a call is made to the mobile communication terminal 10′ while the mobile communication terminal 10′ is swivel-tilted, the user may receive the call in the state shown in FIG. 6. If the tilting angle θ2 is greater than 30°, the upper body 14 and the lower body 12 may be excessively angled relative to each other, and the upper body 14 may be too distant from the face of the user.

If the upper body 14 is too distant from the face of the user, a receiver arranged at the top of the upper body 14 may be too distant from the ear of the user, or a microphone (not shown) in the lower body 12 may be too distant from the mouth of the user. This may increase the difficulty of using the telephone feature of the mobile communication terminal 10′.

Thus, the mobile communication terminal 10′ may have the tilting angle θ2 in the is range of 5° to 30°, and more particularly in the range of 8° to 12°.

By slanting the swivel hinge unit 30 relative to the upper body 14 and lower body 12 as mentioned above, the upper body 14 and lower body 12 arranged at a first angle relative to each before the swiveling movement are tilted with a second angle, the tilting angle θ2, after the swiveling movement.

Meanwhile, border surfaces 44 and 46, arranged where the upper body 14 and lower body 12 contact each other, may have an inclination corresponding to a border axis Z that is perpendicular to the central axis O of the swivel hinge unit 30. If the border axis Z is not perpendicular to the central axis O, the border surfaces 44 and 46 of the upper body 14 and lower body 12 may interference with each other during the swiveling movement, thereby disturbing the swiveling movement. Thus, the border axis Z of the border surfaces 44 and 46 may be perpendicular to the central axis O. Further, the border surfaces 44 and 46 could have a different arrangement that permits the swivel movement of the swivel hinge unit 30 as described above. For example, the border surfaces 44 and 46 could each be partially or entirely curved across the border axis Z, and could each be partially or entirely curved or tilted away from the swivel hinge unit 30 across the border axis Z.

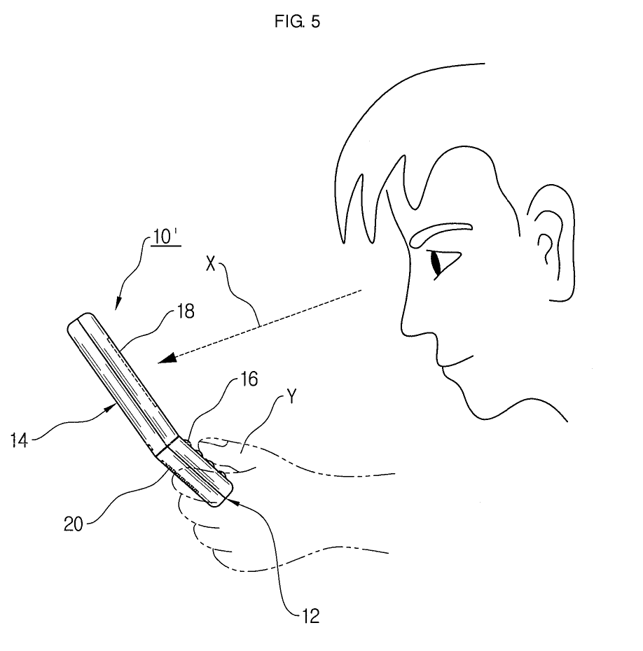

FIG. 5 shows how the mobile communication terminal of this embodiment is used, and in FIG. 5, it is schematically illustrated that a swivel-tilted mobile communication terminal is gripped and used.

As seen from the figure, the upper body 14 is raised toward a vertical direction according to the tilting angle θ2, so the display 18 better faces the gaze X of a user. This may make using the mobile communication terminal 10′ more convenient for the user since the user may more conveniently see the display 18 and more easily watch the content displayed on the is display 18.

In addition, a user may grip the mobile communication terminal 10′ such that his/her thumb Y is placed more substantially in a horizontal direction, and less substantially in a vertical direction, so the user may more conveniently manipulate the key input unit 16 while moving his/her fingers. In other words, the manipulation of the key input unit 16 may be improved.

According to the swivel-tilting-type mobile communication terminal 10′ of this exemplary embodiment, it is possible to improve visibility to the display 18 provided at the upper body 14 and manipulation of the key input unit 16 provided at the lower body 12 together if a user uses a function that permits manipulation of the key input unit 16 while watching the display 18.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile communication terminal, comprising:
an upper body;
a lower body; and
a swivel hinge unit connecting the upper body to the lower body, the swivel hinge unit to perform a swiveling movement of the lower body relative to the upper body from a first position to a second position,
wherein the swivel hinge unit rotates about a central axis arranged with an inclined angle with respect to a first axis formed by the upper body and the lower body in the first position, and
wherein the upper body and the lower body in the second position are arranged relative to each other at a tilting angle.

2. The mobile communication terminal of claim 1, wherein the inclined angle of the swivel hinge unit is ½ of the tilting angle.

3. The mobile communication terminal of claim 2, wherein border surfaces of the upper body and the lower body are arranged perpendicular to the central axis.

4. The mobile communication terminal of claim 2, wherein the tilting angle is 5° to 30°.

5. The mobile communication terminal of claim 1, wherein the swivel hinge unit comprises:
a hinge shaft extending into the upper body and the lower body;
an elastic spring coupled to the hinge shaft;
an upper cam rotatably coupled to the hinge shaft in the upper body;
a lower cam rotatably coupled to the hinge shaft between the elastic spring and the upper cam and engaged with a cam shape of the upper cam;
an upper fixed wing attached to the upper cam; and
a lower fixed wing attached to the lower cam.

6. The mobile communication terminal of claim 2, wherein the swivel hinge unit comprises:
a hinge shaft extending into the upper body and the lower body;
an elastic spring coupled to the hinge shaft;
s an upper cam rotatably coupled to the hinge shaft in the upper body;
a lower cam rotatably coupled to the hinge shaft between the elastic spring and the upper cam and engaged with a cam shape of the upper cam;
an upper fixed wing attached to the upper cam; and
a lower fixed wing attached to the lower cam.

7. The mobile communication terminal of claim 3, wherein the swivel hinge unit comprises:
a hinge shaft extending into the upper body and the lower body;
an elastic spring coupled to the hinge shaft;
an upper cam rotatably coupled to the hinge shaft in the upper body;
a lower cam rotatably coupled to the hinge shaft between the elastic spring and the upper cam and engaged with a cam shape of the upper cam;
an upper fixed wing attached to the upper cam; and
a lower fixed wing attached to the lower cam.

8. The mobile communication terminal of claim 4, wherein the swivel hinge unit comprises:
a hinge shaft extending into the upper body and the lower body;
an elastic spring coupled to the hinge shaft;
an upper cam rotatably coupled to the hinge shaft in the upper body;
a lower cam rotatably coupled to the hinge shaft between the elastic spring and the upper cam and engaged with a cam shape of the upper cam;
an upper fixed wing attached to the upper cam; and
a lower fixed wing attached to the lower cam.

9. The mobile communication terminal of claim 1, wherein the upper body comprises a display, and the lower body comprises a key input unit.

10. A mobile communication terminal, comprising:
an upper body;
a lower body; and
a swivel hinge unit connecting the upper body to the lower body, the swivel hinge unit to swivel the lower body from a first position to a second position relative to the upper body,
wherein the upper body and the lower body in the first position form a first angle, and the upper body and the lower body in the second position form a second angle, and the first angle and the second angle are different.

11. The mobile communication terminal of claim 10, wherein the swivel hinge unit extends along a central axis having an inclined angle relative to the upper body.

12. The mobile communication terminal of claim 10, wherein the first angle is 0 degrees.

13. The mobile communication terminal of claim 10, wherein the second angle is 5° to 30°.

14. The mobile communication terminal of claim 11, wherein the inclined angle is 5° to 15°.
